(19) United States
(12) Patent Application Publication
(10) Pub. No.: US 2022/0340393 A1
(43) Pub. Date: Oct. 27, 2022

(54) LED LIGHT HOSE REEL

(71) Applicant: CEJN AB, Skovde (SE)

(72) Inventors: Leif Nyfelt, Skovde (SE); Mattias Johansson, Skovde (SE)

(21) Appl. No.: 17/762,467

(22) PCT Filed: Oct. 14, 2019
(86) PCT No.: PCT/EP2019/076923

§ 371 Date: Mar. 22, 2022

(30) Foreign Application Priority Data
Sep. 23, 2019 (EP) PCT/EP2019/075552

(51) Int. Cl. B65H 75/40; F21S 4/26; F21V 23/00; F21V 23/06; F21S 9/02

(52) U.S. Cl. CPC B65H 75/40; F21S 4/26; F21V 23/001; F21V 23/06; F21S 9/02; F21Y 2115/10

(57) ABSTRACT

An LED (light-emitting diodes) light hose reel is disclosed, comprising a housing (10); a reel (12) inside the housing (10); a transparent hose (20), the hose (20) being retractably reeled on the reel (12) inside the housing (10); an LED light strip (22) arranged inside the hose (20); an electric power cable (34) for the LED light strip (22); and an electric connection (36) between the LED light strip (22) and the electric power cable (34). A method of storing an LED light strip is disclosed, comprising storing the LED light strip on a retractable reel. A method of using the LED light hose reel is disclosed. The method comprising the following steps in any order: withdrawing the hose (20) from the LED light hose reel; selecting light colour and selecting blinking or constant light by activating the control element (32); attaching the hose (20) to an object; and retracting the hose (20) into the LED light hose reel.

### TECHNICAL FIELD

The present disclosure relates to hose reels. More particularly, the present disclosure relates to a LED (light-emitting diodes) light hose reel and a method of reeling and using the same.

### BACKGROUND

Recent attention has been given more and more to safety in general, specifically where human beings are involved. In many situations there is a need to provide safety features, such as barriers and warnings. To provide these takes time and requires specific means to create a barrier, or to produce warnings and warning signals. Unused barriers, and barriers in use, take space. Warnings also take space. Often there is a space restriction, and environmental issues, where the safety feature is to be used. This and other issues result in that it is time consuming and often difficult to provide safety features, such as barriers and warnings.

To provide a safety feature rendering barriers and visual warnings easily is a problem. To provide this with only one device is a further problem. To provide such a safety feature that takes little physical space and is easy and quick to deploy is also a problem. A further problem with such safety device is mobility. These, as well as other problems are addressed herein.

It is also desirable to provide safety features that are inexpensive to manufacture, are easy to manufacture, and are robust. The safety feature must also be able to provide a good and reliable safety feature. The present disclosure is directed to overcoming one or more of the problems as set forth above.

### SUMMARY OF THE INVENTION

It is an object of the present invention to provide a LED (light-emitting diodes) light hose reel, a method of storing a LED light strip, and a method for using such a LED light hose reel. This object can be achieved by the features as defined by the independent claims. Further enhancements are characterised by the dependent claims.

According to one embodiment, an LED light hose reel, comprises a housing 10; a reel 12 inside the housing 10; a transparent hose 20, the hose 20 being retractably reeled on the reel 12 inside the housing 10; an LED light strip 22 arranged inside the hose 20; an electric power cable 34 for the LED light strip 22; and an electric connection 36 between the LED light strip 22 and the electric power cable 34. The LED light hose reel may further comprise an addition reel 14, the additional reel 14 may be in addition to the reel 12, the additional reel 14 may be configured for retractably reeling an electric cable 15.

According to one embodiment, the LED light hose reel may further comprise a circuit board 30 for controlling the LED light strip 22. The electric connection 36 may be a slip ring electric connection.

According to one embodiment, the LED light hose reel may further comprise a control element 32 on the housing 10, the control element 32 being operatively connected to the circuit board 30 for controlling light options of the LED light strip.

According to one embodiment, the transparent hose 20 may further comprise an attachment element 24 at the end of the transparent hose 20, the end which is outside the housing 10. The attachment means 24 may comprise a magnet and/or a hook.

According to one embodiment, the LED light hose reel may further comprise a battery 40 for supplying the LED light strip with electric power. The LED light hose reel may further comprise a charger 42 for charging the battery 40, the charger 42 may be electrically connected to the electric power cable 34.

According to one embodiment, the LED light hose reel may further comprise a handle 16 and/or a stand 18. Furthermore, an attachment 17 for attaching the LED light hose reel to an object may be provided. The LED light strip 22 may be configured for emitting different colours of light, and the light may be flashing or constant.

According to one embodiment, a method of storing an LED light strip is disclosed. The method comprises storing the LED light strip on a retractable reel.

According to one embodiment, a method of using the LED light hose reel according to any one of the preceding embodiment is disclosed. The method comprises the following steps in any order: withdrawing the hose 20 from the LED light hose reel; and selecting light colour and selecting blinking or constant light by activating the control element 32. The method may further comprise the following steps in any order: attaching the hose 20 to an object; and retracting the hose 20 into the LED light hose reel.

One or more embodiments disclosed herein provide a LED light hose reel. At least one embodiment provides a LED light hose reel that can be operated easily and fast for providing safety features, such as barriers and warnings. At least one embodiment provides a LED light hose reel that is inexpensive to manufacture, is easy to manufacture, is mobile, and is robust. At least one embodiment provides a LED light hose reel providing a good and reliable safety feature. At least one embodiment provides a LED light hose reel providing safety features that takes little physical space and is easy and quick to deploy.

At least one of the above embodiments provides one or more solutions to the problems and disadvantages with the background art. Other technical advantages of the present disclosure will be readily apparent to one skilled in the art from the following description and claims. Various embodiments of the present application obtain only a subset of the advantages set forth. No one advantage is critical to the embodiments. Any claimed embodiment disclosed herein may be technically combined with any other claimed embodiment(s) disclosed herein.

### BRIEF DESCRIPTION OF THE DRAWINGS

The accompanying drawings illustrate presently exemplary embodiments of the disclosure, and together with the general description given above and the detailed description of the embodiments given below, serve to explain, by way of example, the principles of the disclosure.

FIG. 1 is a diagrammatic illustration of an embodiment of a LED light hose reel according to an exemplary embodiment of the present disclosure;

FIG. 2 is a diagrammatic illustration of an exemplary embodiment of the electronic connection that may be used in the embodiment illustrated in FIG. 1; and

FIG. 3 is a diagrammatic illustration of an exemplary flow chart of some components according to an exemplary embodiment of the present disclosure.

### DETAILED DESCRIPTION

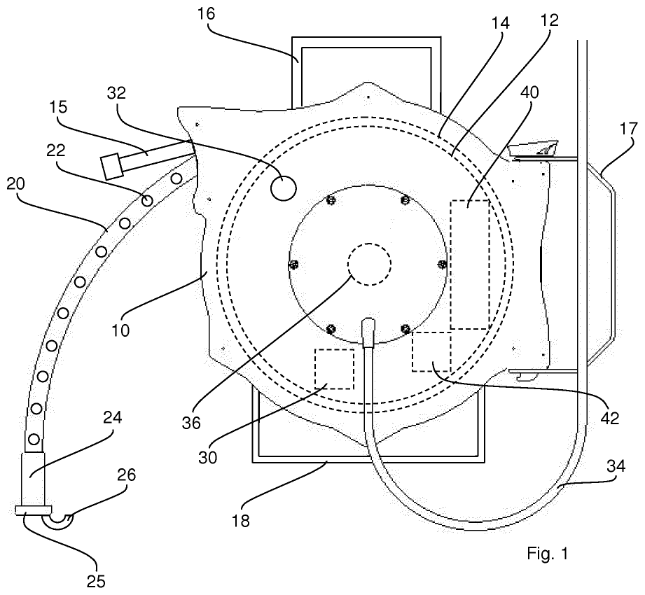

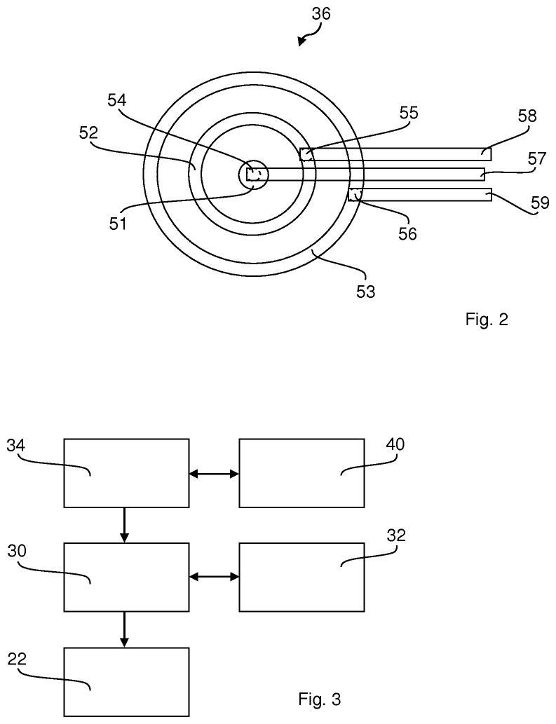

FIGS. 1, 2 and 3 are diagrammatic illustrations of an LED (light-emitting diodes) light hose reel according to an exemplary embodiment of the invention. FIG. 1 illustrates an example of the LED light hose reel, FIG. 2 illustrates the electric connection, an exemplary slip ring connection, and FIG. 3 is an exemplary flow chart of the electronics. Known hose reels do not have electric connections, nor do they have LED light strips. Known electric cable reels do not have reels for hoses, nor do they have LED light strips.

Turning to FIG. 1, the LED (light-emitting diodes) light hose reel, comprises a housing 10; a reel 12 inside the housing 10; a transparent hose 20, the hose 20 being retractably reeled on the reel 12 inside the housing 10; an LED light strip 22 arranged inside the hose 20; an electric power cable 34 for the LED light strip 22; and an electric connection 36 between the LED light strip 22 and the electric power cable 34.

According to an embodiment, the housing 10 may preferably be a moulded housing, preferably injection moulded. The housing 10 may be made out of plastic. The housing 10 may connect and support one or more, or all, features of the LED light hose reel, rendering the LED light house reel a single mobile unit.

According to an embodiment, the hose 20 may be a transparent hose 20 or tube 20. The hose 20 may be a flexible tube, and may be suitable for conveying a fluid, such as for example water, air, compressed air, fuel, etc.

According to an embodiment, the reel 12 may be a drum 12 rotatably arranged within the housing 10. The reel 12 may be moulded, preferably injection moulded. The reel may be moulded as one part or as two or more parts. The reel 12 is a retractable reel 12 allowing the hose 20 un-reeled from the reel 12 to be reeled up again onto the reel 12. Such a reeling up may be initiated by a tug on the hose 20. Reel 12 may be a spring loaded retractable reel 12, such that un-reeling the hose 20 from the reel 12 loads the spring, and the spring subsequently may reel the hose back up onto the reel 12. When the hose 20 is reeled up onto the reel 12, then a portion of the hose 20 may protrude outside the housing 10.

According to an embodiment, the LED light strip 22 may be arranged inside the hose 20 substantially along the whole length of the hose 20. Preferably, the LED light strip 22 is only inside the hose 20, not outside the hose 20. In some embodiments the LED light strip 22 may be arranged in only parts, or separate parts, of the hose 20. The LED light strip 22 may be arranged as a loop inside the hose 20. According to one embodiment, there may be one or two or three or four different, or complementary, LED light strips arranged in the hose 20. The LED light strip 22 may be a LED tape or a ribbon light, such as a flexible circuit board populated by light-emitting diodes, LED. The transparent hose 20 may be air tight, and/or water tight, to protect the LED light strip 22 from the environment and to allow the hose 20 to float on water. According to one embodiment, the LED light strip 22 is arranged along and/or on the outside of the hose 20.

According to an embodiment, the electric power cable 34 may be an electric power cable for supplying AC/DC to the LED light hose reel, in particular to the LED light strip 22 via a circuit board 30. The power cable 34 may extend out from the housing 10 and have at its end, extending out from the housing 10, an electric plug.

According to an embodiment, the electric connection 36 may be a slip ring, a rotary electrical interface, a rotating electrical connector, a collector, a swivel, or an electrical rotary joint. The electric connection allows for transfer of electricity between on one hand the rotating reel 12 with the LED light strip 22 and on the other hand the stationary housing 10. In this way the LED light strip 22 may be fed with electricity. The preferred way of realising this is using a slip ring electric connection 36, for example as illustrated in FIG. 2.

According to one embodiment, the electric connection 36, of the LED light hose reel, may be a slip ring electric connection 36. A simple schematic diagram of such a slip ring 36 is illustrated in FIG. 2. The slip ring 36 may comprise three slip rings 51, 52, and 53, one each for plus, minus, and earth (ground), respectively. These three slip rings 51, 52, and 53 could be arranged on the rotatable reel 12. The slip ring 36 may comprise three pins 54, 55 and 56, as illustrated in FIG. 2. These three pins 54, 55, and 56 could be arranged on the stationary housing 10. The three pins 54, 55, and 56 could in turn be electrically connected to the electric power cable 34 and/or a battery 40, preferably via the circuit board 30. In this way one end of the LED light strip 22 may be fed with electric power. According to one embodiment, the three slip rings 51, 52, and 53 may instead be arranged on the stationary housing 10 and the three pins 54, 55 and 56 may then correspondingly be arranged on the rotating reel 12.

According to one embodiment, the LED light hose reel may further comprise a circuit board 30 for controlling and feeding the LED light strip 22 with electric power. The circuit board 30 may be arranged inside the housing 10, preferably on the stationary housing, and preferably not on the rotatable reel 12. The circuit board 30 may be for controlling the light options, to toggle between them, of the LED light strip. The electric power cable 34 may feed the circuit board 30 with electric power, so that the circuit board 30 in turn can feed the LED light strip 22, and, in some embodiments, feed a battery charger 42.

According to one embodiment, the LED light hose reel may further comprise an addition reel 14, the additional reel 14 may be in addition to the reel 12. The additional reel 14 may be configured for retractably reeling an electric cable 15, preferably with an electric power plug, or socket, at the end. The reeled cable 15 may comprise a stop ball to prevent the cable 15 to be completely reeled up onto the additional reel 14. In this way a user of the LED light hose reel can use the hose 20 with the LED light strip 22 for, for example, warning situations or light, and at the same time use the electric cable 15 of the additional reel 24 for, for example, an electric tool. According to one embodiment, the two reels, the first reel 12 for the hose 20 and the second reel 14 for the electric cable 15, are both retractable reels. This allows unwinding by pulling the hose 20 and/or electric cable 15 by hand, followed by automatically winding up, for example powered by a spring. The additional reel 14 and the reel 12 may be arranged co-axially and side by side to each other within the housing 10. They may be of the same size, or the reel 12 for the hose 20 may be wider than the additional reel 14 for the cable 15, and/or they may both have the same radial extension within the housing 10. The additional reel 14 and the reel 12 may each have an electric connection 36, for example a slip ring each. Preferably each electric connection 36 is arranged, respectively, on the sides of each reel 12, 14 that face away from each other. The additional reel 14 and the reel 12 may rotate independently of each other.

According to one embodiment, the LED light hose reel may further be configured to provide fluid through the transparent hose 20. The fluid may be compressed, and may be compressed air, such as for example air with the pressure of 8 bar. The LED light hose reel may comprise compressed air supply through the transparent hose 20. The hose 20 may comprise the LED light strip 22 and fluid, for example compressed air. The LED light strip 22 may be in a separate tube inside the hose 20, or only the LED light strip 22 may be, by itself, inside the hose 20. The LED light hose reel may be supplied with fluid through a hose 34 as indicated in FIG. 1. The hose 34 may be a combination of an electric cable 34 and a hose 34 for fluid. A technical effect of these embodiments is that the LED light hose reel can be used for supplying compressed fluid, for example, compressed air for hydraulic tools. The one and the same LED light hose reel may provide several functions such as electricity, warning light, and compressed air. This eliminates the need to have separated reels for each or two or more of the functions, and results in saving space. A further technical effect is that the transparent hose 20 becomes stiff and inflated by the compressed air or fluid and this protects the LED light strip 22, for example when the hose 20 is laying on the ground and is driven over by a vehicle, as well as it straightens the hose 20.

According to one embodiment, the LED light hose reel may comprise a hose 20 for a fluid to be reeled up. Fluid comprises liquid and gas, and the hose 20 comprises a LED light strip 22 inside or outside the hose 20. The LED hose light reel may comprise a drum 12 for the hose 20 to be reeled up on and a swivel for a supply of the fluid. The drum may be moulded and may comprise as integral moulded parts: a swivel connector arranged at a central axis, the drum being rotatable about the central axis, a central flow path coaxial with the central axis, and a radial flow path extending radially from the central flow path. The swivel may be connected to the swivel connector.

Fluid comprises liquid and gas, for example water, air, compressed air, fuel, etc. The LED light hose reel may comprise a drum 12, the reel 12, for the hose 20 to be reeled up on. The drum 12 may be rotatably arranged within the housing 10. The drum 12 may be moulded, preferably injection moulded. The drum 12 may be moulded as one part or as two or more parts. The drum 12, the reel 12, may comprise, as integral moulded parts, moulded at the same time as the drum 12 is moulded, moulded in the same moulding process as the moulding process of the drum 12, a swivel connector, a central flow path, and a radial flow path. According to one embodiment, the drum 12, or a part of the drum 12, may comprise, as integral moulded parts, the swivel connector, the central flow path, and the radial flow path, all these three may be moulded in the same moulding process as the drum 12, or a part of the drum 12.

According to one embodiment, the LED light hose reel may further comprise a control element 32 on the housing 10. The control element 32 may be operatively connected to the circuit board 30, as shown in FIG. 3, for controlling the light options of the LED light strip. The control element 32 may be, for example, a switch, a toggle switch, a button, a rotary switch, a cycle button, a toggle button, or similar, and additionally the control element 32 may be one, two or three of these. The control means 32 may be used by a user to toggle between the light functions of the LED light strip, for example between different blinking sequences and solid light, and/or between different colours. The control element 32 for operating the LED light may be arranged on the outside of the housing 10, within an arm length, for example 30 centimetres, from where the hose 20 with the LED light strip 22 comes out from the housing 10. This would allow a user to conveniently change sequence of flashes and colours of the LED light strip.

According to one embodiment, the transparent hose 20 of the LED light hose reel may further comprise an attachment element 24 at the end of the transparent hose 20 which is outside the housing 10. This is the end of the hose 20 that a user grabs hold on to pull the hose 20 out of the LED light hose reel. According to one embodiment, the attachment means 24 may be a magnet 25 and/or a hook 26. The attachment means 24 may also comprise a handle. The end of the hose 20 protruding from the housing 10 may have a magnet 25 or a hook 26, or both, for attaching the hose 20 to an object, such as for example a tree, a pole, a railing, etc. According to one embodiment, the attachment element 24 may function as a stop ball to prevent the hose 20 from completely disappearing inside the housing 10 when reeled up. The attachment means 24 may protrude outside the housing 10 when the hose 20 is fully retracted.

According to one embodiment, the LED light hose reel may further comprise a battery 40 for supplying the LED light strip with electric power. According to a further embodiment, the LED light hose reel may further comprise a charger 42 for charging the battery 40, the charger 42 being electrically connected to the electric power cable 34. This allows a user to charge the LED light hose reel, for example when it is stored. The battery 40 can be replaced to ensure that the LED light hose reel always provides electric power for at least the LED light strip 22. The battery 40 may be arranged on the inside of the housing 10. The battery 40 may be arranged on the outside of the housing 10 to provide an easier exchange of the battery 40. The charger 42 may be supplied with electricity from the circuit board 30, or directly from the electric power cable 34. The LED light hose reel may thus receive electric power from the electric power cable 34, or from the battery 40. The charger 42 may work with a range of currents so that the battery 40 can be charged from, for example, a vehicle or another battery.

According to one embodiment, the LED light hose reel may further comprise a handle 16 and a stand 18. The handle 16 allows the LED light hose reel to be portable, and carried by hand. The stand 18 allows the LED light hose reel to be firmly placed on the ground, or any other place, where it may be needed.

According to one embodiment, the LED light hose reel may further comprise an attachment 17 for attaching the LED light hose reel to an object. The attachment 17 may be a bracket or a holder on the housing 10. This allows for the housing 10 to be attached to the object. The object may be, for example, a vehicle, a wall, a post, a railing, or the ground. If the housing 10 of the LED light house reel is connected to a vehicle, then the LED light hose reel may use electric power supplied by the vehicle, for example via the cable 34.

According to one embodiment, the LED light strip 22, of the LED light hose reel, is configured for emitting different colours of light, and the light may be blinking, flashing, or constant. The light given by the LED light strip 22 may be controlled by the control element 32. In this way light options like, for example, light duration, blinking, flashing, constant light, light colour, etc, may be controlled. This allows the LED light hose reel to be used to create warnings, for example flashing red light, or to be used for lighting up the environment, for example constant white light.

Turning to FIG. 3, a diagrammatic illustration shows an exemplary flow chart of some components according to an exemplary embodiment of the present disclosure. According to one embodiment, the cable 34 may be electrically connected to the circuit board 30. The cable 34, and/or the circuit board 30, may in addition be electrically connected to the battery 40, directly or via the battery charger 42. The circuit board 30 may get electric power from the cable 34 and/or from the battery 40. The circuit board 30 may in turn be electrically connected to the LED light strip 22, preferably via the electric connection 36, for example the slip ring 36. The circuit board 30 may also be electrically connected to the control element 32, to allow a user of the control element 32 to set the light options of the LED light strip 22 via the circuit board 30.

According to one embodiment, a method of storing an LED light strip 22 is disclosed. The method comprises storing the LED light strip 22 on a retractable reel 12. By storing the LED light strip 22 on a retractable reel 12, the LED light strip 22 can be pulled out, and be used easily whenever wanted, and subsequently easily and conveniently stored away by the retractable reel 12. This facilitates readily and easy use of an LED light strip 22.

According to one embodiment, a method of using the LED light hose reel according to any one of the preceding embodiments is disclosed. The method comprises the following steps in any order: withdrawing the hose 20 from the LED light hose reel; and selecting light colour and selecting blinking or constant light by activating the control element 32. The method may further comprise the following steps in any order: attaching the hose 20 to an object; and retracting the hose 20 into the LED light hose reel. Furthermore, a cable 15 for electric power supply may be withdrawn and/or retracted from and onto the additional reel 14. By storing the transparent hose 20 with the LED light strip 22 inside on a retractable reel 12, the LED light strip 22 can be pulled out, and be used easily whenever wanted, and subsequently easily and conveniently stored away by the LED light hose reel. This facilitates readily and easy use of the LED light hose reel to create warnings, for example flashing red light, or to be used for lighting up the environment, for example constant white light.

According to at least one embodiment disclosed herein, an LED light hose reel is provided. At least one embodiment provides a LED light hose reel that can be operated easily and fast for providing safety features, such as barriers and warnings. At least one embodiment provides a LED light hose reel that is inexpensive to manufacture, is easy to manufacture, is mobile, and is robust. At least one embodiment provides a LED light hose reel providing a good and reliable safety feature. At least one embodiment provides a LED light hose reel providing safety features that takes little physical space and is easy and quick to deploy.

It will be apparent to those skilled in the art that various modifications and variations can be made to the LED light hose reel and the method for reeling or using the same. Other embodiments will be apparent to those skilled in the art from consideration of the specification and practice of the disclosed reel. It is intended that the specification and examples be considered as exemplary only, with a true scope being indicated by the following claims and their equivalents.

### LIST OF ELEMENTS FOR THE LED LIGHT HOSE REEL

10 housing
12 reel
14 additional reel
15 cable
16 handle
17 attachment
18 stand
20 transparent hose
22 LED light strip
24 attachment element
25 magnet
26 hook
30 circuit board
32 control element
34 electric power cable
36 electric connection
40 battery
42 charger
51, 52, 53 slip rings
54, 55, 56 pins
57, 58, 59 electric wires

1. An LED, light-emitting diodes, light hose reel, comprising a housing (10);
a reel (12) inside the housing (10);
a transparent hose (20), the hose (20) being retractably reeled on the reel (12) inside the housing (10);
an LED light strip (22) arranged inside the hose (20);
an electric power cable (34) for the LED light strip (22); and
an electric connection (36) between the LED light strip (22) and the electric power cable (34).

2. The LED light hose reel according to claim 1, further comprising a circuit board (30) for controlling the LED light strip (22).

3. The LED light hose reel according to claim 1 or 2, wherein the electric connection (36) is a slip ring electric connection.

4. The LED light hose reel according to any one of the preceding claims, further comprising an addition reel (14), the additional reel (14) being in addition to the reel (12), the additional reel (14) being configured for retractably reeling an electric cable.

5. The LED light hose reel according to any one of the preceding claims, configured for supplying a compressed fluid, preferably compressed air, through the transparent hose (20).

6. The LED light hose reel according to any one of the preceding claims, further comprising a control element (32) on the housing (10), the control element (32) being operatively connected to the circuit board (30) for controlling light options of the LED light strip.

7. The LED light hose reel according to any one of the preceding claims, wherein the transparent hose (20) further comprises an attachment element (24) at the end of the transparent hose (20), the end which is outside the housing (10).

8. The LED light hose reel according to claim 7, wherein the attachment means (24) comprises a magnet and/or a hook.

9. The LED light hose reel according to any one of the preceding claims, further comprising a battery (40) for supplying the LED light strip with electric power.

10. The LED light hose reel according to claim 9, further comprising a charger (42) for charging the battery (40), the charger (42) being electrically connected to the electric power cable (34).

11. The LED light hose reel according to any one of the preceding claims, further comprising a handle (16) and a stand (18); and/or further comprising an attachment (17) for attaching the LED light hose reel to an object.

12. The LED light hose reel according to any one of the preceding claims, wherein the LED light strip (22) is configured for emitting different colours of light, and the light being blinking or constant.

13. A method of storing an LED light strip, comprising storing the LED light strip on a retractable reel.

14. A method of using the LED light hose reel according to any one of the preceding claims, the method comprising the following steps in any order:
withdrawing the hose (20) from the LED light hose reel; and
selecting light colour and selecting blinking or constant light by activating the control element (32).

15. The method according to claim 14, the method further comprising the following steps in any order:
attaching the hose (20) to an object; and
retracting the hose (20) into the LED light hose reel.
